(19) United States
(12) Patent Application Publication
(10) Pub. No.: US 2026/0162385 A1
(43) Pub. Date: Jun. 11, 2026

(54) ELECTRONIC DEVICE AND METHOD FOR IMAGE PROCESSING

(71) Applicant: Samsung Electronics Co., Ltd., Suwon-si (KR)

(72) Inventors: Jinwon GO, Suwon-si (KR); Sungjae LEE, Suwon-si (KR); Seoyoung LEE, Suwon-si (KR); Sangjun PARK, Suwon-si (KR)

(21) Appl. No.: 19/436,886

(22) Filed: Dec. 30, 2025

Related U.S. Application Data
(63) Continuation of application No. PCT/KR2025/021290, filed on Dec. 10, 2025.

(30) Foreign Application Priority Data
Dec. 11, 2024 (KR) 10-2024-0183876

(51) Int. Cl. G06T 19/00

(52) U.S. Cl. CPC G06T 19/006

(57) ABSTRACT

An electronic device and a method are disclosed. The electronic device may include a memory including at least one storage medium storing instructions, a display, a communication unit, and at least one processor including processing circuitry. At least one processor may be configured to obtain at least one of ambient condition information or positional relationship information, perform first image processing to obtain at least one intermediate image, perform second image processing based on at least one of the ambient condition information or the positional relationship information to obtain at least one simulation image, and display the at least one simulation image via the display.

### CROSS-REFERENCE TO RELATED APPLICATIONS

This application is a continuation of International Application No. PCT/KR2025/021290 designating the United States, filed on Dec. 10, 2025, in the Korean Intellectual Property Receiving Office and claiming priority to Korean Patent Application No. 10-2024-0183876, filed on Dec. 11, 2024, in the Korean Intellectual Property Office, the disclosures of each of which are incorporated by reference herein in their entireties.

### BACKGROUND

### Field

The disclosure relates to an electronic device for image processing and a method related to its control.

### Description of Related Art

Reflective display technology has advantages of high visibility and low power consumption unlike conventional displays. A reflective display may minimize/reduce power consumption because it mainly displays screens by reflecting external light, and is widely used in e-books, smart tags, electronic billboards, or the like. A reflective display may include e-paper.

Technology reflecting user selection to provide a viewing experience desired by users in image processing is also developing importantly. This technology enables providing screens of desired quality by reflecting settings such as brightness, color contrast, and sharpness preferred by users. Such user selection reflecting technology contributes to increasing user satisfaction and providing consistent quality in various viewing environments.

The above-described information may be provided as related art for the purpose of aiding in understanding of the disclosure. No assertion or determination is made as to whether any of the foregoing is applicable as background art in relation to the disclosure.

### SUMMARY

According to an example embodiment of the disclosure, an electronic device may be provided. The electronic device may include: a display, a memory including at least one storage medium storing at least one instruction, and at least one processor, comprising processing circuitry, individually and/or collectively, configured to execute the at least one instruction, and to cause the electronic device to perform various operations.

According to an example embodiment, at least one processor, individually and/or collectively, may be configured to cause the electronic device to: perform first image processing on an original image to obtain at least one intermediate image, perform second image processing on the at least one intermediate image based on at least one of ambient condition information or positional relationship information to obtain at least one simulation image, and display the at least one simulation image via the display of the electronic device, wherein the intermediate image may include an image for display via an external reflective display device, the ambient condition information may include ambient illuminance information, and the positional relationship information may include information about at least one of a distance or a direction of the reflective display device relative to the electronic device.

According to an example embodiment, the second image processing may be performed based on the ambient condition information, the positional relationship information, and optical characteristic information of the reflective display device, and the optical characteristic information of the reflective display device may include at least one of reflectance of the display of the reflective display device or display luminance of the reflective display device.

According to an example embodiment, at least one processor, individually and/or collectively, may be configured to cause the electronic device to: generate optical characteristic information of the reflective display device based on red-green-blue (RGB) data obtained by capturing the display of the reflective display device and ambient illuminance information.

According to an example embodiment, the second image processing may be performed based on the ambient condition information, the positional relationship information, the optical characteristic information of the reflective display device, display performance information of the reflective display device, and display performance information of the electronic device, the ambient condition information may further include at least one of position information of an ambient light source or ambient color temperature information, and the performance information may include at least one of size or resolution.

According to an example embodiment, the first image processing may include image processing obtaining a plurality of different intermediate images based on different image processing setting information for an original image, the image processing setting information may include information about an image processing algorithm, and the plurality of intermediate images may include a plurality of images obtained based on different types of image processing algorithms or a plurality of images obtained based on a same type of image processing algorithm and different attribute values. The second image processing may be image processing obtaining a plurality of simulation images from the plurality of intermediate images based on at least one of the ambient condition information or the positional relationship information.

According to an example embodiment, at least one processor, individually and/or collectively, may be configured to cause the electronic device to: transmit a signal to the reflective display device causing at least one intermediate image corresponding to at least one image selected among the plurality of intermediate images to be displayed as a final image, based on identifying the selection of the at least one image from the plurality of simulation images. The reflective display device may be configured to display the final image based on the received signal.

According to an example embodiment, the simulation image may be an image related to an appearance to be seen from a position of the electronic device corresponding to the positional relationship information based on the intermediate image being displayed via the display of the reflective display device.

According to an example embodiment, at least one processor, individually and/or collectively, may be configured to cause the electronic device to: identify a change in the ambient condition information and display a simulation image updated based on the change in the ambient condition information via the display.

According to an embodiment, at least one processor, individually and/or collectively, may be configured to cause the electronic device to: adjust brightness displaying the simulation image on the display based on at least one of the ambient condition information or display brightness setting information of the electronic device.

According to an embodiment, at least one processor, individually and/or collectively, may be configured to cause the electronic device to: capture an image of a real space including the reflective display device, identify a position and a shape of the reflective display device in the image of the real space, overlay the simulation image on the shape of the reflective display device on the image of the real space, and display the image of the real space and the overlaid simulation image on the display.

According to an example embodiment, at least one processor, individually and/or collectively, may be configured to cause the electronic device to: perform first image processing on a first original image to obtain at least one first intermediate image and a second intermediate image. A first simulation image obtained by second image processing based on the ambient condition information and a first positional relationship for the first intermediate image may have a same visual appearance as a second simulation image obtained by second image processing based on the ambient condition information and a second positional relationship for the second intermediate image, and the same visual appearance may refer, for example, to an appearance having a same or similar shape and same perceptual image features within a predetermined error range.

According to an example embodiment, at least one processor, individually and/or collectively, may be configured to cause the electronic device to: perform first image processing on a second original image to obtain at least one third intermediate image. A third simulation image obtained by second image processing based on the ambient condition information and the second positional relationship for the third intermediate image may have a consistent visual appearance with the first simulation image. The consistent visual appearance may refer, for example, to an appearance having same perceptual image features within a predetermined error range.

According to an example embodiment, a method of operating an electronic device may be provided. The method of operating the electronic device may comprise: performing first image processing on an original image to obtain at least one intermediate image, performing second image processing on the at least one intermediate image based on at least one of ambient condition information or positional relationship information to obtain at least one simulation image, and displaying the at least one simulation image via a display of the electronic device.

An example method of operating an electronic device according to an example embodiment of the disclosure may include: generating optical characteristic information of the reflective display device based on RGB data obtained by capturing the display of the reflective display device and ambient illuminance information.

An example method of operating an electronic device according to an example embodiment of the disclosure may include: identifying selection of at least one image from the plurality of simulation images, and transmitting a signal to the reflective display device causing at least one intermediate image corresponding to at least one image selected among the plurality of intermediate images to be displayed as a final image based on identifying the selection of the at least one image.

An example method of an electronic device according to an example embodiment of the disclosure may include: capturing an image of a real space including the reflective display device, identifying a position and a shape of the reflective display device in the image of the real space, overlaying the simulation image on the shape of the reflective display device on the image of the real space, and displaying the image of the real space and the overlaid simulation image on the display.

### BRIEF DESCRIPTION OF THE DRAWINGS

The same or similar reference denotations may be used to refer to the same or similar elements throughout the disclosure, including the drawings. Further, the above and other aspects, features and advantages of certain embodiments of the present disclosure will be more apparent from the following detailed description, taken in conjunction with the accompanying drawings, in which:

FIG. 1A is a block diagram illustrating an example configuration of an electronic device according to various embodiments.

FIG. 1B is a block diagram illustrating an example configuration of a display device according to various embodiments.

FIG. 2 is a diagram illustrating an example surrounding environment including an electronic device and an external display according to various embodiments.

FIGS. 3A and 3B include a flowchart and a diagram illustrating example operations of an electronic device obtaining a simulation image according to various embodiments.

FIGS. 4A and 4B include a flowchart and a diagram illustrating an example operation of an electronic device obtaining and using a plurality of simulation images according to various embodiments.

FIG. 5 is a diagram illustrating an example electronic device implementing a simulation image in augmented reality according to various embodiments.

FIG. 6 is a flowchart illustrating an example operation of an electronic device according to various embodiments.

FIG. 7 is a diagram illustrating an example of a screen displayed on a display of an electronic device according to various embodiments.

FIG. 8 is a diagram illustrating an example electronic device and several external displays according to various embodiments.

FIG. 9 is a diagram illustrating several external displays forming a video wall according to various embodiments.

### DETAILED DESCRIPTION

Hereinafter, various example embodiments of the disclosure are described in greater detail with reference to the drawings. However, the disclosure may be implemented in many different forms and is not limited to the various embodiments described herein, but should be understood to include various modifications, equivalents, or alternatives. The disclosure may be modified in various ways by one of ordinary skill in the art without departing from the scope of the claims, and such modified embodiments should not be individually understood from the technical spirit or prospect of the disclosure.

Hereinafter, in the drawings and related descriptions, functions and configurations, technical terms and technical details that are well known in the technical field to which the disclosure belongs may be omitted. This is to convey the core issues of the disclosure more clearly and concisely by minimizing/reducing unnecessary details.

In the drawings, each block of the flowchart drawings and combinations of flowchart drawings may be performed by at least one instruction. The instructions may be installed in a processor of a computer or other programmable data processing equipment to produce means for performing the functions described in the drawings. The instructions may provide steps for performing the functions described in the drawings by being executed on a computer or other programmable data processing equipment.

Various elements and areas in the drawings are schematically drawn, and the technical spirit of the disclosure is not limited by the relative sizes, spacing, or arrangements drawn in the attached drawings. The electronic device of the disclosure is not limited to the configuration and/or operation in the drawings, and may include all other configurations capable of performing the same or similar functions.

The individual components depicted in the drawings are not necessarily physically distinct, but are separated to aid the description and understanding of the disclosure. The disclosure may include configurations in which individual components illustrated in the drawings are merged, modified, or some components are deleted and/or added. Likewise, the operations depicted in the drawings are illustrative to aid description and understanding, and the disclosure may be modified by merging or changing the order of the operations depicted in the drawings, or deleting and/or adding some of the operations. For example, two or more operations depicted sequentially in a drawing may be performed substantially simultaneously or, as necessary, in reverse order.

In the drawings and the following description, ‘image’ or terms including ‘image’ may include video data in addition to static images.

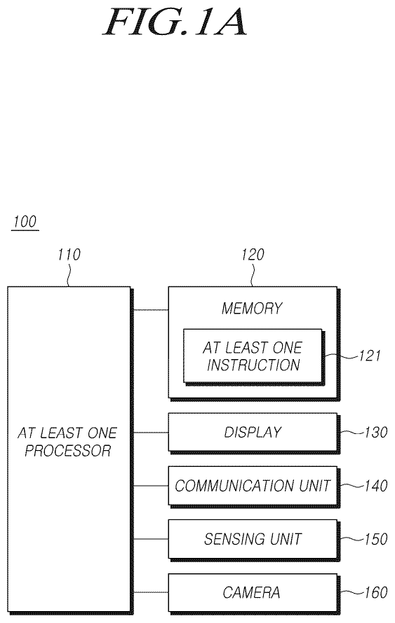

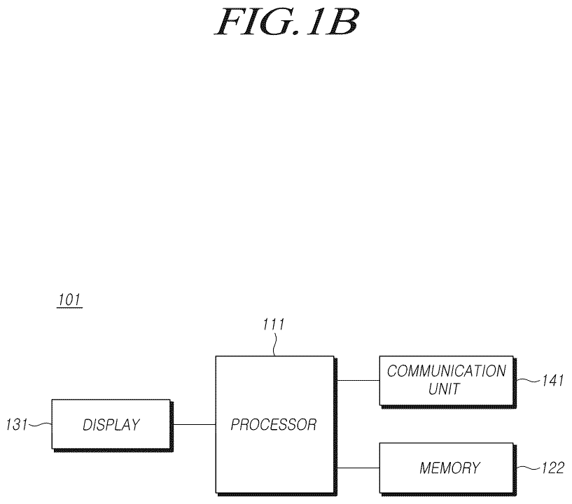

FIG. 1A is a block diagram illustrating an example configuration of an electronic device according to various embodiments.

The electronic device 100 of FIG. 1A may be, but is not limited to, a smartphone, a tablet PC, a PC, a TV, a smart TV, a mobile phone, a personal digital assistant (PDA), a laptop computer, a media player, a micro server, a digital broadcast terminal, a navigation, a kiosk, a home appliance, or other mobile or non-mobile computing devices. The electronic device 100 may perform various computing functions, such as real-time video viewing and communication. The various embodiments of the disclosure for the electronic device 100 below may be equally applied to other electronic devices.

According to an embodiment, an electronic device 100 may include at least one processor (e.g., including processing circuitry) 110, a memory 120, a display 130, a communication unit (e.g., including communication circuitry) 140, a sensing unit (e.g., including at least one sensor) 150, and/or a camera 160.

According to an embodiment, the memory 120 may include a storage medium used by the electronic device 100 and may store data, such as at least one command 121 or configuration information corresponding to at least one program. The program may include an operating system (OS) program and various application programs. At least one instruction 121 stored in the memory 120 may, when executed by the at least one processor 110, cause the electronic device 100 to perform at least one operation.

According to an embodiment, the memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, and optical discs.

According to an embodiment, the display 130 may perform functions for outputting information in the form of numbers, characters, images, and/or graphics. The display 130 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 130 may display a screen corresponding to data received from the processor 110. The display 130 may be referred to as an ‘output unit’, a ‘display unit’, or by other terms having an equivalent technical meaning.

According to an embodiment, the display 130 may perform various display operations according to functions of the electronic device 100. For example, the display 130 may display various types of information such as numbers, letters, images, graphics, or tables. The display 130 may form a layer structure with a touch pad to form a touch screen. In this case, the display 130 may be used as an input interface as well as the output interface. The display 130 may be one independent display or may include a plurality of displays. The plurality of displays may be disposed at different positions.

According to an embodiment, the electronic device 100 may include a communication unit 140. The communication unit 140 may include various communication circuitry and perform a function for the electronic device 100 to receive data from outside or transmit data to outside. The communication unit 140 may be connected to a network or exchange data with other devices through wired and/or wireless communication methods. For example, the communication unit 140 may support various communication protocols such as Wi-Fi, Bluetooth, near field communication (NFC), 4G/5G mobile communication networks, Ethernet, or USB. Further, the communication unit 140 may manage a connection state with external devices and enable external devices to remotely control operations of the electronic device 100.

The communication unit 140 may support a post-4G 5G network and next-generation communication technology, e.g., new radio (NR) access technology. The NR access technology may support enhanced mobile broadband (eMBB), massive machine type communications (mMTC), or ultra-reliable and low-latency communications (URLLC). The communication unit 140 may support a high-frequency band (e.g., the mmWave band) to achieve, e.g., a high data transmission rate. The communication unit 140 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The communication unit 140 may support various requirements specified in the electronic device 100, the external electronic device, or the network system. According to an embodiment, the communication unit 140 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

According to an embodiment, the communication unit 140 may receive data transmitted from an external sensor. The data transmitted from the sensor may include ambient condition information sensed by the sensor. The ambient condition information is a term comprehensively referring to various physical characteristics measured or analyzed in the surrounding environment, and may include at least one of elements such as, e.g., illuminance, light source position, color temperature, ambient reflection, temperature, humidity, noise level, or air pressure. Ambient conditions may also be referred to by various terms such as, e.g., surrounding conditions, ambient environmental factors, or environmental variables.

According to an embodiment, the electronic device 100 may include the sensing unit 150. The sensing unit 150 may include at least one sensor and perform a function for sensing various external signals interacting with the electronic device 100. The sensing unit 150 may include various types of sensors capable of measuring physical states such as distance, direction, illuminance, position of a light source, or color temperature.

According to an embodiment, the sensing unit 150 may sense an operation state (e.g., power or temperature) of the electronic device 100 or an external environmental state (e.g., user state) and generate an electrical signal or data value corresponding to the sensed state. According to an embodiment, the sensing unit 150 may perform a function for sensing various external signals interacting with the electronic device 100. For example, it may include at least one of an illuminance sensor, a color temperature sensor, an RGB (red-green-blue) sensor, a distance sensor, a direction sensor, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, or a humidity sensor.

According to an embodiment, the electronic device 100 may include the camera 160. The camera 160 may capture still images and videos and may include at least one of one or more lenses, image sensors, image signal processors, or flashes.

According to an embodiment, the at least one processor 110 may include various processing circuitry and execute control of at least a portion of the electronic device 100, image processing, computation, and/or data processing by executing at least one instruction 121 stored in the memory 120.

According to an embodiment, the at least one processor 110 may include at least one processing circuit and/or multiple processors. One or more of the at least one processor 110 may be configured to individually and/or collectively perform various functions described in the disclosure. In the disclosure, in case that it is described that “processor”, “at least one processor”, or “one or more processors” are configured to perform various functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 110 may include, e.g., a combination of processors performing various functions cited/initiated in a distributed manner. The at least one processor 110 may execute program instructions to achieve or perform various functions.

According to an embodiment, the at least one processor 110 may include at least one of a central processing unit (CPU), a graphic processing unit (GPU), a neural network processing unit (NPU), a micro controller unit (MCU), a sensor hub, a supplementary processor, a communication processor, an application processor, an application specific integrated circuit (ASIC), or field programmable gate arrays (FPGA) and may have multiple cores.

According to an embodiment, the at least one processor 110 may identify presence of an external device connected via the communication unit 140 and receive information related to the external device. For example, it may identify an external reflective display and receive information about the reflective display.

According to an embodiment, the at least one processor 110 may obtain a positional relationship between an external device and the electronic device 100 via the communication unit 140 and/or the sensing unit. The positional relationship may include a distance and/or a direction between the external device and the electronic device 100.

According to an embodiment, the at least one processor 110 may perform image processing. For example, the at least one processor 110 may analyze an input image to identify a subject or extract specific attributes of the input image. Image processing may be referred to as, e.g., image processing.

According to an embodiment, image processing that the at least one processor 110 may perform may include at least one of the following examples: dithering, edge detection, noise reduction, color correction, resolution adjustment, brightness adjustment, sharpness adjustment, contrast adjustment, or image stitching.

According to an embodiment, dithering may include a technique for smoothly adjusting color or brightness differences of an image to represent natural gradations. Dithering may be used, e.g., to enhance visual quality of images in environments with limited color palettes or resolution. For example, dithering may form visible gradations by mixing adjacent colors with small dots in areas lacking colors, thereby representing colors or gradations.

According to an embodiment, in a reflective display, dithering may perform a role enabling expression of detail and gradations of images within limited color and brightness ranges. Since a reflective display displays images by reflecting external lighting, it may be greatly affected by fixed color limitations and ambient lighting. Applying dithering in such environments may enhance sharpness and/or visual clarity of images even with limited colors on the reflective display.

According to an embodiment, image processing may be related to at least one image processing setting information. The at least one processor 110 may adjust quality of an input image or enhance specific attributes based on such image processing setting information during image processing. The image processing setting information may include information about image quality parameters and/or image processing algorithms.

According to an embodiment, the image processing setting information may be used to optimize visual quality and processing effects of images and may be used for various adjustment tasks to enhance user experience or adapt original images to displays for output.

According to an embodiment, image quality parameters may include variables related to overall visual characteristics of images. For example, image quality parameters may include variables such as brightness, contrast, color saturation, sharpness, and color gamut.

According to an embodiment, information about image processing algorithms may include settings related to types, configurations, and/or application strengths of specific algorithms used in image processing. For example, information about image processing algorithms may include information such as types of image processing, parameters (e.g., blur strength in Gaussian blur algorithm), dithering strength, and edge detection sensitivity.

According to an embodiment, dithering strength may be a parameter determining how strongly dithering is applied. For example, higher dithering strength may form smoother gradations as small dots are disposed more densely, but image detail may decrease. Conversely, e.g., lower dithering strength makes gradation expression less smooth but image detail may appear more clearly. Dithering strength may be adjusted according to display characteristics, viewing environment, and/or user requirements (e.g., requirements according to user preferences or selections).

According to an embodiment, the at least one processor 110 may perform image processing for simulation. The simulation may be related to implementing how it would appear, e.g., the appearance, at the position of the electronic device 100 in case that an actual object is positioned at a specific location or an actual image is displayed at a specific location. Using the simulation, the at least one processor 110 may enable users to experience the actual environment in advance. An image implemented using the simulation may be referred to as a ‘simulation image’ in the disclosure.

According to an embodiment, the at least one processor 110 may analyze an image (e.g., an image input via the camera 160) to obtain related data (e.g., RGB data, illuminance data). As such, the at least one processor 110 may perform the role of sensors (e.g., RGB sensor, illuminance sensor) using images captured by the camera 160.

According to an embodiment, the at least one processor 110 may cause a user interface (UI) to be displayed on the display 130. The UI may include, e.g., buttons, menus, or icons for accepting user input. The UI may provide information such as, e.g., current system status, warning notifications, and task progress. Further, the UI may be changed or updated in real-time according to user operations, and adjustments such as color, layout, and size adjustment may be possible based on user-customized settings.

According to an embodiment, the UI displayed on the display 130 by the at least one processor 110 may include, e.g., an interface related to a plurality of sample images and/or selection options for selecting images to be displayed on an external display (e.g., reflective display). In this case, in case that the external display is a display with relatively slow screen update speed (e.g., e-paper), time required for screen updates may be saved by identifying various selection options in advance on the electronic device 100 and then displaying only finally selected images on the external display. Accordingly, user experience may be enhanced.

FIG. 1B is a block diagram illustrating an example configuration of a display device according to various embodiments.

Referring to FIG. 1B, according to an embodiment, a display device 101 may include a display 131, a communication unit (e.g., including communication circuitry) 141, a memory 122, and a processor (e.g., including processing circuitry) 111. According to an embodiment, the display device 101 may include additional components (e.g., user interface) besides the illustrated components or may omit at least one of the illustrated components.

According to an embodiment, the display 131 may visually provide information (e.g., text and/or images) to the outside of the display device 101. The display 131 may also include, e.g., a control circuit for controlling the display 131.

According to an embodiment, the display 131 may be a reflective display, e.g., a display displaying images by reflecting ambient light, but the disclosure is not limited thereto. The display 131 may include, e.g., an e-paper display, an e-ink display, a mirasol display, an electrophoretic display, an electrochromic display, a reflective liquid crystal display (RLCD), or micro-electro-mechanical systems (MEMS). A reflective display may be driven with low power as it does not require a backlight, and may maintain visibility even in case that external illuminance is high because it reflects ambient light. Further, since a reflective display reflects natural light without using artificial light sources such as backlights and may maintain static images for extended periods, eye fatigue due to blue light or flicker may be decreased.

According to an embodiment, a reflective display may include a reflective surface and driving elements. The reflective surface may be a physical surface forming images by reflecting external light sources, and the driving elements may be elements adjusting intensity, color, or transparency of light reflected from the reflective surface according to electrical signals. The luminance of a reflective display may be proportional to the reflectance of the reflective surface.

According to an embodiment, the luminance of a reflective display may be proportional to ambient illuminance. For example, in case that ambient illuminance is E, reflectance of the reflective surface is R, and relative luminance of an image displayed on the reflective display is Lᵣ, the luminance L of the reflective display may be represented as follows:

$$L = E \times R \times {L}_{r}$$

According to an embodiment, relative luminance may be a value between 0 and 1, being 1 for white (R:255, G:255, B:255) and 0 for black (R:0, G:0, B:0). Relative luminance may be obtained using RGB data and a relative luminance formula applying weights from the CIE 1931 XYZ color space (assigning high weight to green reflecting human visual sensitivity). For example, relative luminance Lr may be obtained by obtaining RGB data, converting to linear RGB data by performing inverse transformation of gamma correction in case that the acquired RGB data is gamma-corrected values, and substituting linear RGB values into the following formula:

$${L}_{r} = 0.2126 R + 0.7 \; 152 G + 0.0722 B$$

According to an embodiment, according to the formulas, in case that reflectance of the reflective surface of a reflective display (e.g., display 131) and external illuminance information are available, the luminance in case that a specific image with given RGB data is displayed on the reflective display may be known without actually displaying the specific image.

According to an embodiment, an electrophoretic display (e.g., electrophoretic e-paper display), which is a type of reflective display, may include charged particles and a fluid medium. The charged particles and fluid medium have clearly distinguishable colors for image representation, e.g., the charged particles may be white and the fluid medium may be black. An electrophoretic display may display desired patterns and/or images by applying an electric field perpendicular to its surface to move charged particles. For example, an electrophoretic display may include other charged particles with opposite charges instead of a fluid medium, and in this case (e.g., white negatively charged particles and black positively charged particles), the image display principle may be the same.

According to an embodiment, an electrophoretic display may have relatively slower image update speed compared to non-reflective displays (e.g., LCD). This may be because the time for charged particles to move within the fluid medium is physically limited. Further, according to an embodiment, in case of updating images, an electrophoretic display may be preceded by an operation updating the entire screen (e.g., displaying the entire screen black then white again) before the image update operation to prevent and/or reduce ghosting phenomena where afterimages remain. This may require more time.

According to an embodiment, reflective displays with principles other than electrophoretic displays may also have slow image update speeds. For example, a cholesteric liquid crystal display (C-LCD) uses the principle that liquid crystal molecules selectively reflect light through specific arrangements (e.g., selectively reflecting light of specific wavelengths according to the pitch between helical periods in helical molecular arrangements), and image update speed may be limited because time is required for rearrangement of liquid crystal molecules. Similarly, an electrochromic display uses the principle that specific materials change color by specific electrical signals (e.g., C₁₈Fe₇N₁₈ changes from transparent to blue in case that specific voltage is applied), and image update speed may be limited because time is required for the color change reaction of materials in this process. Thus, generally, reflective displays may have characteristics of relatively slow update speeds to maintain energy efficiency.

According to an embodiment, the constraints on image update speed in the above-described reflective displays may deteriorate user experience by reducing visual quality or responsiveness of user interfaces. For example, in case of trying to change image processing setting information (e.g., dithering strength) for output on a reflective display, there may be a wait for image update time each time a setting is changed.

According to an embodiment, the communication unit 141, including communication circuitry, may support establishment of wireless or wired communication channels between the display device 101 and external electronic devices (e.g., the electronic device 100 of FIG. 1A), and/or performing communication via established communication channels.

According to an embodiment, the communication unit 141 may be operated independently from the processor (e.g., an application processor) 250 and may include one or more communication processors that support wireless communication or wired communication. According to an embodiment, the communication unit 141 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via a first network (e.g., a short-range communication network, such as Bluetooth™, Bluetooth low energy (BLE), Wi-Fi, Wi-Fi direct (WFD), or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

According to an embodiment, the memory 122 may store various data or information used by at least one component of the display device 101 (e.g., display 131, communication unit 141, or processor 111). For example, the memory 122 may store at least one program for processing and control of the processor 111, and may store input and/or output data (e.g., images or content). The memory 122 may also store at least one artificial intelligence (AI) model and may include volatile memory or non-volatile memory.

According to an embodiment, the processor 111 may include various processing circuitry and control the overall operation of the display device 101. The processor 111 may execute operations or data processing related to control and/or communication of at least one other component of the display device 101. For example, the processor 111 may be electrically connected to the display 131, communication unit 141, and memory 122, and may control operations of the display device 101 by executing instructions of programs stored in the memory 122.

According to an embodiment, the processor 111 may perform afterimage compensation operations based on a first application. For example, the processor 111 may determine afterimage compensation operations based on information received from the external electronic devices (e.g., the electronic device 100 of FIG. 1A) and control the display 131 or control circuits included in the display 131 to perform the determined afterimage compensation operations. According to an embodiment, the processor 111 may perform operations of the display device 101 to be described below.

According to an embodiment, the processor 111 may correspond to a plurality of processors performing a plurality of operations divided among processors individually or collectively. As set forth above with reference to the processor 110 of FIG. 1A, the processor 111 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 111 may include a processing circuit that executes instructions of the program stored in the memory 122. The processor 111 may include at least one of a central processing unit (CPU), a neural processing unit (NPU), a graphics processing unit (GPU), a micro processing unit (MPU), a micro controller unit (MCU), an application processor (AP), a communication processor (CP), a system on chip (SoC), or an integrated circuit (IC) sensor hub, a supplementary processor, a communication processor, an application specific integrated circuit (ASIC), or a field programmable gate arrays (FPGA), and may include a plurality of cores.

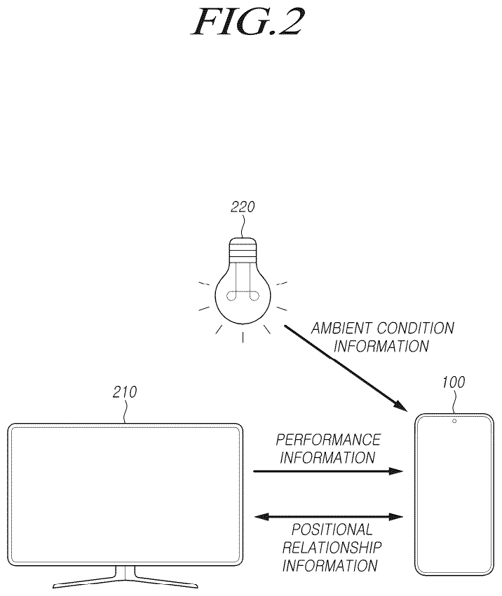

FIG. 2 is a diagram illustrating an example electronic device 100 and a surrounding environment of the electronic device 100 according to various embodiments.

Referring to FIG. 2, according to an embodiment, the electronic device 100 may be connected to an external display 210 wirelessly and/or wiredly. For example, the electronic device 100 may be connected to the external display 210 through wireless communication methods such as Bluetooth and NFC and/or wired communication methods such as USB and high-definition multimedia interface (HDMI) to exchange information with each other.

According to an embodiment, the electronic device 100 may receive information about the external display 210 from the external display 210. The information about the external display 210 may include, e.g., performance information of the external display 210 (e.g., resolution, brightness range, color gamut, viewing angle, etc.).

According to an embodiment, the electronic device 100 may obtain positional relationship information between the electronic device 100 and the external display 210. The positional relationship information between the electronic device 100 and the external display 210 may include at least one of distance information or direction information of the external display 210 relative to the electronic device 100.

According to an embodiment, the electronic device 100 may obtain distance information to the external display 210 based on distance sensing technology. The distance sensing technology may be technology using at least one of ultra-wideband (UWB), signal (e.g., communication signal, laser, infrared) arrival time or reflected return time (e.g., LiDAR technology), received signal strength indicator (RSSI), frequency modulation, camera-based distance measurement (e.g., triangulation, depth from defocus), or phase shift.

According to an embodiment, the electronic device 100 may obtain direction information to the external display 210 based on direction sensing technology. The direction sensing technology may be technology using at least one of UWB, angle of arrival, beamforming, magnetometer, camera-based image analysis (e.g., shape analysis, feature matching), inertial measurement unit (IMU), or phase information.

According to an embodiment, the electronic device 100 may obtain performance information of the external display 210. The performance information may include at least one of, e.g., size, brightness range, contrast ratio, ambient contrast ratio (ACR), refresh rate, resolution, color gamut, reflectance, color depth, viewing angle, or surface reflectance.

According to an embodiment, the external display 210 may be an independent display device (e.g., display device 101 of FIG. 1B) rather than a simple display panel. For example, the external display 210 may include its own processor (e.g., the processor 111 of FIG. 1B) and memory (e.g., memory 122 of FIG. 1B) to operate independently, and may maintain screens or perform information display functions without connection to the electronic device 100.

According to an embodiment, the external display 210 may receive a specific signal from the electronic device 100 and perform an operation based on the received signal (e.g., an operation displaying a specific image on its display (e.g., display 131 of FIG. 1)).

According to an embodiment, the electronic device 100 may obtain information about ambient conditions. For example, referring to FIG. 2, the electronic device 100 may obtain illuminance due to an ambient light source 220 and/or position information of the ambient light source 220.

According to an embodiment, the electronic device 100 may receive ambient condition information from external sensors through the communication unit 140 and, in case that the electronic device 100 includes a sensing unit (e.g., internal illuminance sensor), it may also directly sense ambient condition information using the sensing unit.

According to an embodiment, according to the positional relationship between the electronic device 100 and the external display 210 and/or ambient conditions (e.g., ambient illuminance, position of ambient light source 220), the actual visible appearance of an image displayed on the external display 210 at the position of the electronic device 100 may vary. For example, in case that the external display 210 is a reflective display, as the distance between the electronic device 100 and the external display 210 increases, details of the image seen from the electronic device 100 may become faint, and brightness and/or contrast may be perceived as decreasing. Further, e.g., as ambient illuminance increases, readability of images may enhance due to greater influence of ambient light due to characteristics of reflective displays.

According to an embodiment, in case that the external display 210 is a reflective display, the electronic device 100 may obtain the luminance of the external display 210 in case that a specific image with known per-pixel relative luminance information is displayed using reflectance of the reflective surface, ambient illuminance information, and/or RGB data of the external display 210 (e.g., substituting into the formulas described above for the display 131 of FIG. 1).

According to an embodiment, in case that the external display 210 is a reflective display, even in case that the electronic device 100 does not know the reflectance of the reflective surface, it may obtain relative luminance from RGB data of the external display 210, assume that absolute luminance of portions where relative luminance of the external display 210 is 1 equals external illuminance (unit conversion required), e.g., assume that the brightest portion reflects 100% of ambient light, thereby estimating the luminance of the entire external display 210 in case that a specific image with per-pixel relative luminance information (or RGB data) is displayed on the external display 210. In case that the overall luminance is estimated, reflectance may also be estimated, and the luminance in case that a specific image is displayed on the external display 210 may be predicted even in case that ambient illuminance changes.

According to an embodiment, the brightness to be perceived at the position of the electronic device 100 in case that a specific image is displayed on the external display 210 may be estimated based on the luminance in case that a specific image is displayed on the external display 210 and/or positional relationship information between the electronic device 100 and the external display 210. For example, the perceived brightness may be proportional to luminance, inversely proportional to the square of distance according to the inverse square law, and proportional to the cosine value of the angle between the direction of the electronic device 100 relative to the external display 210 and the normal to the surface of the external display 210.

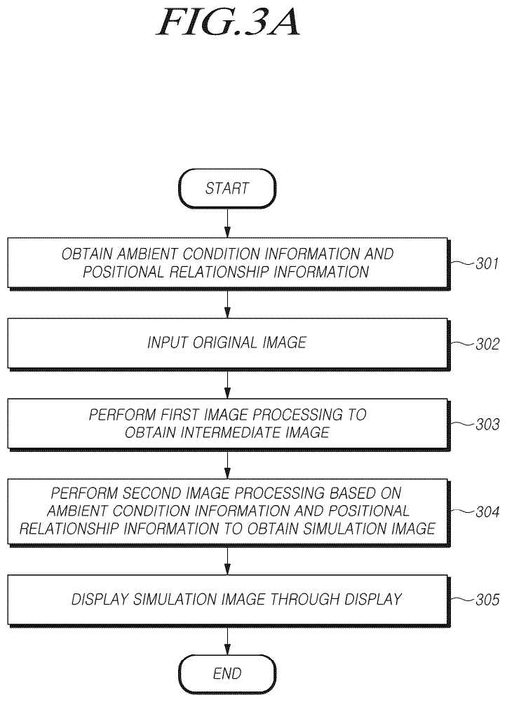

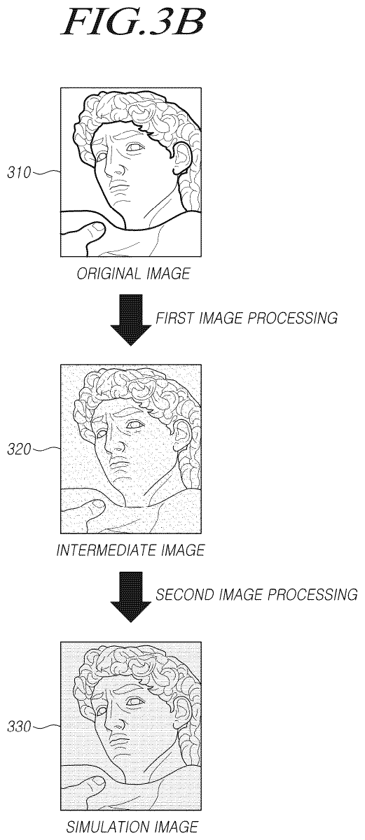

FIG. 3A is a flowchart illustrating an example operation of an electronic device obtaining and displaying a simulation image according to various embodiments.

FIG. 3B is a diagram illustrating an example operation of an electronic device obtaining and displaying a simulation image according to various embodiments.

Hereinafter, for consistency of description and convenience of understanding, terms may be as follows:
Original image: An original image input to the electronic device 100.
Intermediate image: An image obtained by the electronic device 100 performing image processing on an original image so that it may be displayed via an external display (e.g., external reflective display). An intermediate image may be displayed via an external display, but is not necessarily actually displayed. In case that a specific image among intermediate images is displayed on an external display, that specific image may be referred to as a ‘final image’.
Simulation image: An image obtained by performing image processing on an intermediate image to simulate on the display 130 of the electronic device 100 the image that would be seen in case that the intermediate image were displayed via an external display. For example, a simulation image may be an image implementing the appearance that would actually be seen from the position of the electronic device 100 in case that an intermediate image is displayed on an external display.
First image processing: Not referring to image processing of a specific algorithm, but comprehensively referring to all image processing in the stage of obtaining an intermediate image from any original image. For example, first image processing may include dithering on an original image.
Second image processing: Not referring to image processing of a specific algorithm, but comprehensively referring to all image processing in the stage of obtaining a simulation image from any intermediate image. For example, second image processing may include brightness adjustment on an intermediate image.

In operation 301, according to an embodiment, the electronic device 100 may obtain ambient condition information and/or positional relationship information between the electronic device 100 and the external display. The method (or process or operation) of obtaining ambient condition information and/or positional relationship information may be, e.g., as described in connection with FIG. 2. The obtained information may be used for second image processing in subsequent processes.

In operation 302, according to an embodiment, the electronic device 100 may receive an original image (e.g., original image 310). The electronic device 100 may receive the original image in digital data format from the display 130, a network server, or user input.

Referring to FIGS. 3A and 3B, according to an embodiment, the original image 310 may be inappropriate for direct display via an external display and may require first image processing for display on the external display. For example, in case that the original image 310 is a high-resolution image (e.g., an image with 256-level grayscale and 10-bit color information) exceeding the display performance of the external display, first image processing including an algorithm for reducing resolution may be required.

In operation 303, according to an embodiment, the electronic device 100 may perform first image processing to obtain an intermediate image (e.g., intermediate image 320). The first image processing may include, e.g., resolution adjustment, brightness and contrast correction, and dithering algorithm application of the original image. For example, the electronic device 100 may apply first image processing to a high-resolution original image (e.g., an image with 256-level grayscale and 10-bit color information) to obtain an intermediate image with relatively low resolution that may be displayed via an external display (e.g., an image with 16-level grayscale and 8-bit color information).

According to an embodiment, there may be more than one intermediate image for one original image, and the electronic device 100 may cause only some of the one or more intermediate images to be displayed via the external display.

In operation 304, according to an embodiment, the electronic device 100 may perform second image processing based on ambient condition information and positional relationship information to obtain a simulation image (e.g., simulation image 330).

According to an embodiment, in case that the image display speed and/or image update speed of the external display is slow (e.g., in case that the external display is a reflective display), the electronic device 100 may enhance user convenience by displaying or updating the simulation image 330 via the display 130.

According to an embodiment, in case of simulating without special image processing on the intermediate image 320 (e.g., using the image as is or with only simple quality adjustment processing), there may be a difference between the user experience in case that the intermediate image 320 is actually displayed on the external display and the visual appearance of the simulation image 330. For example, even in case that the same image is displayed on the external display, in case that ambient illuminance changes or the distance and/or angle with the external display changes, the visual appearance of the actually seen image may vary.

According to an embodiment, as there is a difference in visual appearance between in case that the intermediate image 320 is actually displayed on the external display and in case that the simulation image 330 is displayed on the display 130, it may be difficult to properly achieve the purpose of simulation. For example, in case that the purpose of simulation is to adjust image characteristics (e.g., brightness, contrast, sharpness) of the intermediate image 320, in case that there is a difference in visual appearance between in case that the actual image is displayed on the external display 210 and in case that the simulation image is displayed on the display 130, the accuracy of simulation decreases and the purpose may not be achieved. Accordingly, user experience may deteriorate.

According to an embodiment, having a difference in visual appearance may refer, for example, to having a difference exceeding a specific range in perceptual image features. Perceptual image features may refer, for example, not to the image characteristics (e.g., brightness) of the image itself in case that a specific image is displayed via a specific display (e.g., external display, display 130 of electronic device 100), but the image characteristics actually sensed at a specific position (e.g., brightness visible to the eye or sensed via a camera).

According to an embodiment, perceptual image features may be objectively measured by objective numerical values and/or parameters regarding measurable visual characteristics such as color, contrast ratio, brightness, saturation, and sharpness. Whether two images with the same or very similar shapes associated with the same original image have the same visual appearance may be determined, e.g., based on whether the perceptual image features of the two images are the same within a predetermined error range. For example, in case that the color difference (ΔE) between two images is 2 or less, contrast ratio difference is 5% or less, and brightness difference (nits) is ±10 or less, it may be difficult to perceive significant differences with the naked eye. In case that perceptual image features are the same within such a predetermined error range, they may be defined as having ‘the same visual appearance’. Perceptual image features, in case of being quantified, may be referred to as ‘perceptual image parameters’, which may be utilized as objective evaluation indicators for determining visual identity.

According to an embodiment, two images associated with different original images may also have a consistent visual impression in case that their perceptual image features are similar. For example, in case that perceptual image features between two images with different shapes are the same within a predetermined error range, they may be defined as having a ‘consistent visual appearance’. Two or more images with consistent visual appearance may give users a visually consistent feeling. For example, in case that different images displayed via multiple external displays have different shapes but actual visible brightness, contrast ratio, etc. are the same within a specific error range, those images may provide a consistent visual experience.

The same visual appearance and/or consistent visual appearance may include other perceptual image feature differences being the same within a predetermined error range, in addition to the color difference, contrast ratio difference, and brightness difference in the examples. The predetermined error range is not limited to the examples and may be appropriately selected to meet the purposes of various embodiments.

In the description of perceptual image features, to distinguish between cases where two or more images are related to the same original image versus different original images, it was assumed that ‘shape’ is not included in perceptual image features. Shape may refer, for example, to a comprehensive concept defining the form of an object's appearance and/or structure in physical space. For example, shape may include size, contours of two-dimensional images, and/or forms of surfaces of three-dimensional images.

In operation 304, according to an embodiment, the electronic device 100 may perform second image processing considering ambient condition information and/or positional relationship information between the electronic device 100 and the external display. The positional relationship information between the electronic device 100 and the external display may include distance and/or direction of the external display relative to the electronic device 100.

According to an embodiment, the electronic device 100 may consider optical characteristic information of the external display during second image processing. The optical characteristic information may include at least one of luminance or reflectance.

According to an embodiment, in case that the electronic device 100 performs second image processing based on ambient condition information and positional relationship information between the electronic device 100 and the external display in the process of obtaining a simulation image (e.g., simulation image 330 of FIG. 3B) from an intermediate image (e.g., intermediate image 320 of FIG. 3B), it may enhance the user's visual experience and provide accurate simulation compared to simulating without special image processing. For example, by obtaining the simulation image 330 by second image processing based on ambient condition information and positional relationship information between the electronic device 100 and the external display, it is possible to have the same visual appearance in case that the intermediate image 320 is displayed on the external display and in case that the simulation image 330 is displayed on the external display.

According to an embodiment, the second image processing may have different image processing setting information based on ambient condition information. For example, in case that the external display is a reflective display (e.g., e-paper), due to its characteristics, brightness, contrast, and contrast ratio of displayed images may be perceived as high in high-illuminance environments (e.g., 1000 lux or more) and low in low-illuminance environments (e.g., 100 lux or less). For example, the electronic device 100 may obtain a simulation image reflecting ambient illuminance from an intermediate image by adjusting settings of the second image processing according to ambient illuminance. Besides ambient illuminance, similarly, influences according to ambient environmental elements such as ambient color temperature and position of ambient light sources may be reflected.

According to an embodiment, the second image processing may have different image processing setting information based on positional relationship information between the electronic device 100 and the external display. For example, in case of viewing an image displayed on an external display up close, detailed elements (e.g., boundaries, patterns of dithering dots) may be perceived in detail and, in case of viewing from a distance, detailed elements may become faint and distortion of brightness or color due to ambient conditions (e.g., illuminance, color temperature) may be perceived more significantly. Similarly, as the viewing angle deviates from the front, brightness and/or contrast of the displayed image may be perceived as lower according to the viewing angle of the external display. The electronic device 100 may obtain a simulation image reflecting positional relationship information by adjusting settings of the second image processing, reflecting such changes in perceptual image features according to positional relationship information.

According to an embodiment, the electronic device 100 may perform second image processing considering reflectance and/or luminance of the reflective surface of the external display, in addition to ambient condition information and positional relationship between the electronic device 100 and the external display. For example, the second image processing may include an algorithm adjusting brightness of the intermediate image according to brightness expected to be perceived at the position of the electronic device 100, considering ambient illuminance, reflectance of the reflective surface, and positional relationship.

According to an embodiment, the electronic device 100 may change setting information of the second image processing by further considering performance information (e.g., resolution, size) of the external display and/or performance information of the display 130. For example, in case that the resolution of the intermediate image 320 and maximum resolution of the display 130 are higher than the maximum resolution of the external display, the second image processing may include an algorithm reducing the resolution of the intermediate image 320 (e.g., linear interpolation downscaling).

In operation 305, according to an embodiment, the electronic device 100 may display the simulation image obtained by performing the second image processing via the display (e.g., display 130 of FIG. 1A). For example, the electronic device 100 may identify changes in ambient condition information in real-time or periodically, update the simulation image 330 by applying second image processing with an algorithm changed based on changes in ambient condition information, and display the updated simulation image via the display 130.

According to an embodiment, the electronic device 100 may adjust brightness displaying the final image via the external display based on ambient condition information and/or brightness setting information of the display 130. For example, in case that the ambient environment is bright, it may output with increased overall brightness of the final image, or in case that brightness of the display 130 is set to maximum, it may output with decreased brightness of the final image.

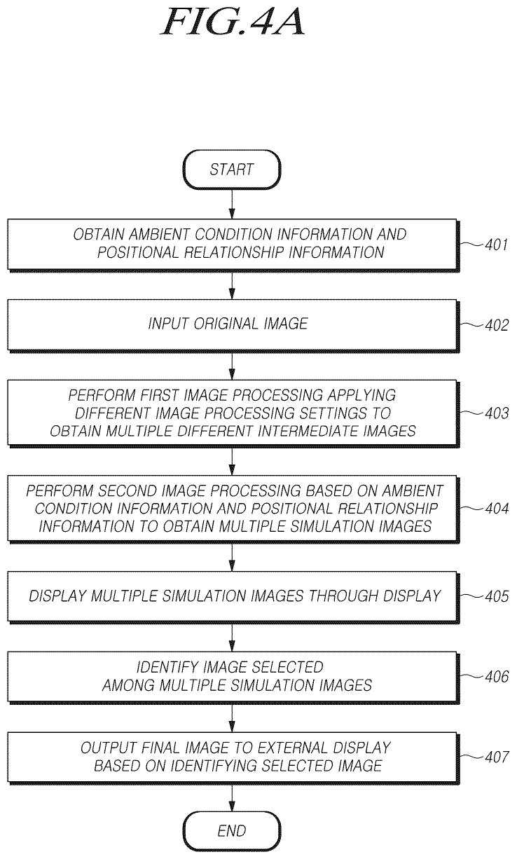

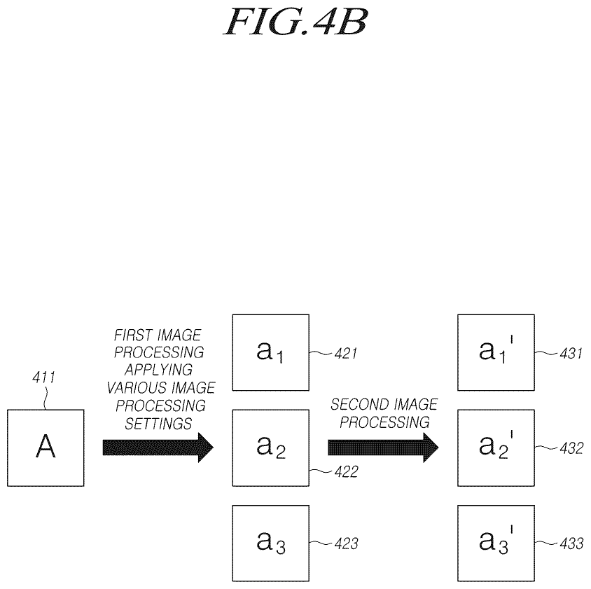

FIG. 4A is a flowchart illustrating an example operation of an electronic device obtaining and displaying a plurality of simulation images according to various embodiments.

FIG. 4B is a diagram illustrating an example operation of an electronic device obtaining and displaying a plurality of simulation images according to various embodiments.

In FIG. 4B, images are represented with alphabets (e.g., letters) for intuitive understanding. A represents an example of an original image, aᵢ (i=1, 2, 3) represents examples of intermediate images, and aᵢ′ (i=1, 2, 3) represents examples of simulation images.

In operation 401, an electronic device (e.g., the electronic device 100 of FIG. 1A) may obtain ambient condition information and positional relationship information. This may be directly obtained via sensors built into the electronic device 100 (e.g., sensing unit 150 of FIG. 1A) or obtained from external sensors via a communication unit (e.g., communication unit 140 of FIG. 1A).

In operation 402, according to an embodiment, the electronic device 100 may receive an original image (e.g., original image 411). The original image may be input, e.g., through user input.

In operation 403, according to an embodiment, the electronic device 100 may perform first image processing applying various image processing settings to original image A 411 to obtain a plurality of different intermediate images a₁ 421, a₂ 422, a₃ 423. The image processing settings may include information about image processing algorithms. Different image processing settings may be, e.g., different types of image processing algorithms or the same type of image processing algorithm with different attribute values. For example, for A 411, a₁ 421 may be an intermediate image obtained by applying ordered dithering, a₂ 422 by applying Floyd-Steinberg dithering, and a₃ 423 by applying Jarvis dithering.

According to an embodiment, various image processing settings in the first image processing may be determined arbitrarily or considering various factors. For example, various image processing settings may be determined based on at least one of user input, user preference data, pre-adjusted settings, ambient condition information, characteristics of original image A (411), or performance of the external display to display the final image.

Referring to FIGS. 4A and 4B, according to an embodiment, by the electronic device 100 obtaining a plurality of intermediate images by applying various image processing settings, it is possible to output an intermediate image having image characteristics desired by the user as the final image. For example, in case that a₁ 421, a₂ 422, and a₃ 423 have different brightness and sharpness, it is possible to output an image having the degree of brightness and/or sharpness desired by the user.

In operation 404, according to an embodiment, the electronic device 100 may perform second image processing based on ambient condition information and positional relationship information between the electronic device 100 and the external display on the plurality of intermediate images to obtain a plurality of simulation images. For example, referring to FIG. 4B, a₁′ 431 may be obtained by applying second image processing to a₁ 421, a₂′ 432 by applying second image processing to a₂ 422, and a₃′ 433 by applying second image processing to a₃ 423.

Referring to FIGS. 4A and 4B, according to an embodiment, a₂′ 431, a₂′ 432, and/or a₃′ 433 may be images related to implementation of the appearance that would be seen in case that a₁ 421, a₂ 422, and/or a₃ 423 are displayed on the external display, respectively.

In operation 405, according to an embodiment, the electronic device 100 may display the plurality of simulation images via the display (e.g., display 130 of FIG. 1A). For example, referring to FIG. 4B, the electronic device 100 may display a₁′, a₂′, and a₃′.

In operation 406, according to an embodiment, the electronic device 100 may identify a selected image among the plurality of simulation images. The selection may be, e.g., selection by a user input. The selected image may be one or multiple images.

In operation 407, according to an embodiment, the electronic device 100 may output the final image to the external display based on identifying the selected image. The final image may be at least one image among the plurality of intermediate images, which is an image corresponding to at least one selected image among the plurality of simulation images. For example, referring to FIG. 4B, based on identifying that a₂′ is selected among the simulation images, the electronic device 100 may output a₂ corresponding to a₂′ to the external display as the final image.

According to an embodiment, the electronic device 100 outputting or displaying a specific image on the external display may refer, for example, to transmitting a signal causing the external display to display the specific image, and causing the external display to display the specific image based on receiving that signal. The external display may be an independent display device (e.g., display device 101 of FIG. 1B) and may be configured to display a specific image based on receiving that signal from the electronic device 100.

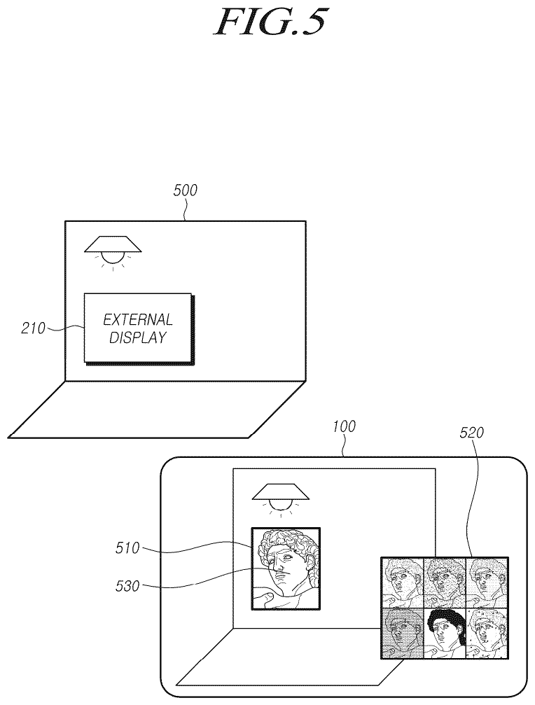

FIG. 5 is a diagram illustrating an example electronic device displaying a simulation image according to various embodiments.

Referring to FIG. 5, according to an embodiment, the simulation image 530 may be an image implementing the intermediate image in augmented reality (AR). In other words, the electronic device 100 may obtain an image of a real space 500 including the external display 210 (e.g., obtained via camera 160 of FIG. 1A), identify the position and shape of the external display 210 portion in the image of the real space 500, overlay the simulation image 530 on the shape 510 of the external display 210 on the image of the real space, and display it via the display 130.

According to an embodiment, the electronic device 100 may display a plurality of simulation images (e.g., plurality of simulation images 520 of FIG. 4B) on the display 130. The electronic device 100 may output only some of the plurality of simulation images 520 as the simulation image 530 in augmented reality. For example, the simulation image 530 in augmented reality may be displayed larger than each of the plurality of simulation images 520, allowing users to identify image quality in more detail.

According to an embodiment, the operation of identifying the position and shape of the external display 210 portion in the image of the real space 500 may be implemented using an artificial intelligence model, such as a deep learning-based object detection algorithm. The deep learning-based object detection algorithm may automatically identify the external display 210 within images captured by the camera and extract contour and position data of the external display 210 to enable accurate overlay of the simulation image 530.

According to an embodiment, compared to general simulation displaying only simulation images alone, the simulation image 530 in augmented reality may provide a more immersive and realistic user experience. For example, since augmented reality simulation includes an image of the real space 500, which is the physical environment where the external display 210 is actually installed, it may allow users to intuitively understand how the result of the final image displayed on the external display 210 will appear in the real space 500.

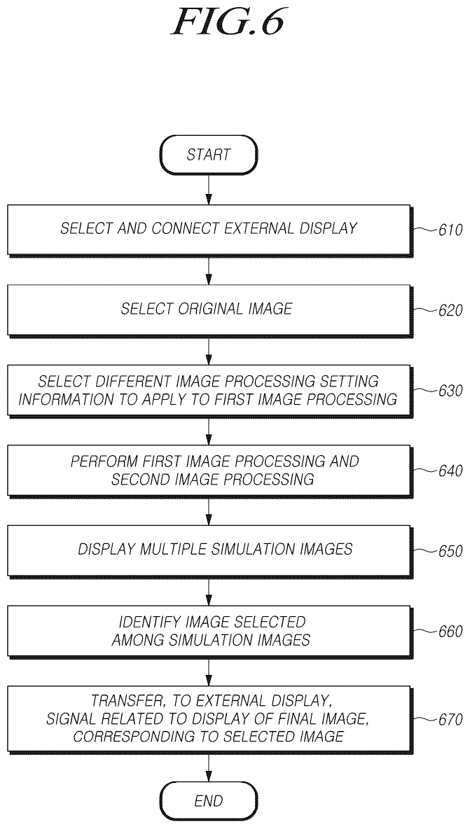

FIG. 6 is a flowchart illustrating an example operation of an electronic device according to various embodiments.

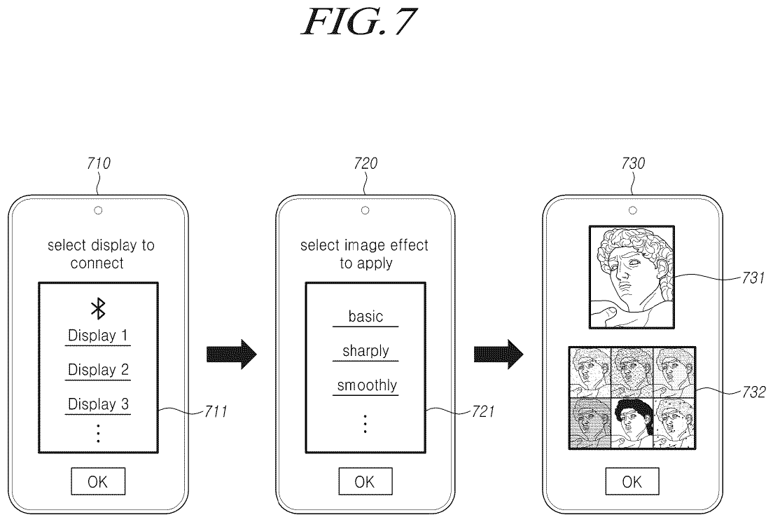

FIG. 7 is a diagram illustrating an example screen displayed on a display of an electronic device according to an operation according to various embodiments.

Referring to FIGS. 6 and 7, according to an embodiment, the electronic device 100 may select and connect to an external display (e.g., the external display 210 of FIG. 2) to connect (operation 610). To that end, the electronic device 100 may display a screen 710 for external display selection via the display 130. The screen 710 for external display connection may include a list 711 of surrounding external displays recognized via wireless communication and/or an identification button. The electronic device 100 may, e.g., select an external display based on interaction between the user and the UI on the display 130 and connect to the external display to be selected.

In operation 620, according to an embodiment, the electronic device 100 may select an original image. The electronic device 100 may, e.g., display a related UI on the display 130 that supports selecting an original image or uploading an original image based on input provided by UI interaction with the user. For example, in case that a user uploads a specific image through the UI, the electronic device 100 may select that image as the original image.

Referring to FIGS. 6 and 7, in operation 630, according to an embodiment, the electronic device 100 may select different image processing setting information to apply to the first image processing (operation 630). To that end, the electronic device 100 may display a screen 720 for selecting image processing setting information via the display 130. The screen 720 for selecting image processing setting information may include a list 721 associated with at least one image processing setting information and/or an identification button. The list 721 may be, e.g., text directly displaying names of image processing algorithm types or numerical values of image processing parameters, or may be simplified text (e.g., ‘sharply’) for intuitive understanding by users.

In operation 640, according to an embodiment, the electronic device 100 may perform first image processing according to the selected different image processing setting information to obtain a plurality of intermediate images. Subsequently, the electronic device 100 may perform second image processing based on ambient environment information and positional relationship information between the electronic device 100 and the external display (e.g., the external display 210 of FIG. 2). According to an embodiment, the electronic device 100 may further consider at least one of reflectance of the external display, luminance of the external display, performance information of the external display, or performance information of the display 130 to determine image processing setting information for the second image processing.

Referring to FIGS. 6 and 7, in operation 650, according to an embodiment, the electronic device 100 may display multiple simulation images via the display 130. To that end, the electronic device 100 may display a screen 730 supporting identifying and selecting simulation image samples via the display 130. Users may compare multiple simulation images at once as in screen 730, or may identify simulation images one at a time. The screen 730 for identifying simulation image samples may include a plurality of simulation images 732 and a simulation image 731 displayed large for detailed identifying among them. The large displayed simulation image 731 may be an image selected by a user input (e.g., touch) among the simulation images 732. The electronic device 100 may display an image corresponding to the selection among the intermediate images as the final image on the external display (e.g., the external display 210 of FIG. 2) in response to selecting one of the simulation images (e.g., selection based on user input).

In operation 660, according to an embodiment, the electronic device 100 may identify image selected among simulation images. For example, the electronic device 100 may identify the selected image based on a user input via the display 130.

In operation 670, according to an embodiment, the electronic device 100 may transfer, to external display (e.g., the external display 210 of FIG. 2), signal related to display of final image corresponding to selected image. The external display may be configured to display the final image based on receiving the signal from the electronic device 100.

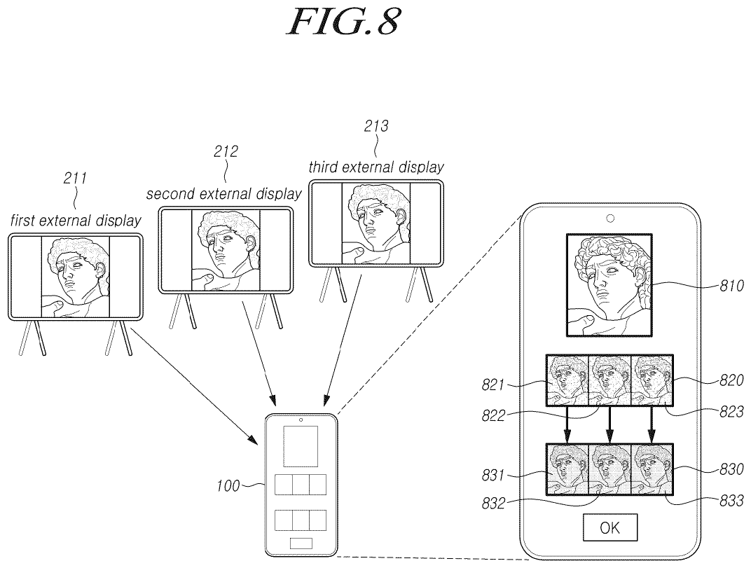

FIG. 8 is a diagram illustrating an example electronic device and several external displays according to various embodiments.

Referring to FIG. 8, according to an embodiment, the electronic device 100 may simultaneously connect to a first external display 211, a second external display 212, and/or a third external display 213. In other words, the electronic device 100 may be simultaneously connected to a plurality of external display devices (e.g., display device 101 of FIG. 1). In this case, since the positions of each external display are all different, the positional relationship information between the electronic device 100 and each external display may all be different. For example, even in case of displaying the same final image via each external display, the visual appearance at the position of the electronic device 100 may be different for each. For example, even in case of displaying the same image, it may be perceived as darker in case of being viewed at an angle than in case of being viewed from the front, and may be perceived as clearer and brighter in case of being viewed up close than from a distance.

According to an embodiment, the original image 810, different intermediate images 820, and/or different simulation images 830 illustrated in FIG. 8 may be displayed on the display (e.g., the display 130 of FIG. 1A), but may be present or be obtained as data and not actually be displayed on the display 130.

According to an embodiment, the electronic device 100 may perform first image processing based on a plurality of image processing setting information about the same original image 810 to obtain different intermediate images 820. The different intermediate images 820 may include a first intermediate image 821, a second intermediate image 822, and/or a third intermediate image 823.

According to an embodiment, the electronic device 100 may obtain a first simulation image 831 by performing second image processing based on ambient condition information and positional relationship information between the electronic device 100 and the first external display on the first intermediate image 821, a second simulation image 832 by performing second image processing based on ambient condition information and positional relationship information between the electronic device 100 and the second external display on the second intermediate image 822, and a third simulation image 833 by performing second image processing based on ambient condition information and positional relationship information between the electronic device 100 and the third external display on the third intermediate image 823.

According to an embodiment, the first simulation image 831, the second simulation image 832, and the third simulation image 833 may have the same visual appearance. In other words, the plurality of simulation images 830 obtained by performing second image processing on the different intermediate images 820 may all have the same or similar shapes and have the same perceptual image features within a predetermined error range.

According to an embodiment, the electronic device 100 may perform first image processing by appropriately setting different image processing setting information so that each simulation image has the same appearance. The appropriate settings may be determined based on inverse calculation of the second image processing.

For example, for convenience of understanding and description, assume that the first external display 211 is far from the electronic device 100 with a large angle (e.g., viewing at an angle), the second external display 212 is close with a small angle (e.g., viewing close to front), and the third external display 213 is excluded from the description. Due to the effects of distance and angle, in case that an image is displayed on the first external display 211, the image seen from the position of the electronic device 100 may be perceived as having lower brightness and sharpness than the displayed image. For example, considering each positional relationship information under the assumption that ambient condition information is the same, the second image processing for the first intermediate image 821 may include relatively more brightness and/or sharpness reduction related algorithms compared to the second image processing for the second intermediate image 822. For example, to have the first simulation image 831 and the second simulation image 832 have the same visual appearance, conversely, it may be identified that the first intermediate image 821 should have higher brightness and sharpness compared to the second intermediate image 822. In other words, the first image processing obtaining the first intermediate image 821 from the same original image may include relatively more brightness and/or sharpness increase related algorithms compared to the first image processing obtaining the second intermediate image 822.

Explaining using formulas with example numerical values, it is as follows (1) to (7):
(1) An image displayed on the first external display is perceived at 0.5 times brightness at the position of the electronic device, and an image displayed on the second external display is perceived normally (1.0 times) at the position of the electronic device 100. This is reflected in the second image processing.
(2) The brightness of the original image is L₀=100.
(3) Ultimately, we want to perceive images at the same brightness (L₁=L₂=50) on both displays. To that end, both the first simulation image and the second simulation image should be displayed at a brightness of 50.
(4) The brightness of the first intermediate image is B₁ and the brightness of the second intermediate image is B₂.
(5) According to item 1 above, the brightness of the first simulation image obtained by applying second image processing to the first intermediate image is 0.5B₁, and the brightness of the second simulation image obtained by applying second image processing to the second intermediate image is B₂.
(6) As 0.5B₁=L₁=L₂=B₂=50, therefore B₁=100 and B₂=50.
(7) Therefore, it may be identified that the first image processing obtaining the first intermediate image B₁=100 from the original image L₀=100 should include a 1.0× brightness algorithm, and the first image processing obtaining the second intermediate image B₂=50 should include a 0.5× brightness algorithm. In other words, the brightness adjustment algorithm of the first image processing obtaining the first intermediate image may have, e.g., double the attribute value related to the brightness adjustment multiplier compared to the brightness adjustment algorithm of the first image processing obtaining the second intermediate image.

According to an embodiment, in case that different intermediate images 820 causing each of the plurality of simulation images 830 to have the same visual appearance are displayed on their corresponding external displays as final images (e.g., in case that the first intermediate image 821 is displayed on the first external display 211), the same visual experience may actually be provided to users viewing each external display from the position of the electronic device 100. According to an embodiment, the principle for simulating the same visual appearance described above may be equally applied to simulate consistent visual appearance even in case that different original images are displayed on each external display.

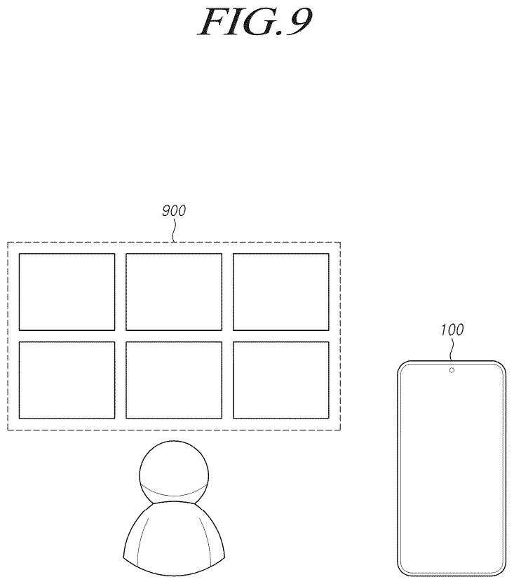

FIG. 9 is a diagram illustrating an example including several external displays forming a video wall according to various embodiments.

According to an embodiment, a video wall 900 may refer, for example, to a display system where multiple displays are physically arranged or synchronized via a network to operate like one integrated screen.

According to an embodiment, a video wall may include an environment where different external displays are present at different positions. The electronic device 100 may perform first image processing with appropriately set different image processing setting information using inverse calculation of second image processing based on each positional relationship information and ambient environment information (e.g., description of FIG. 8) so that simulation images associated with the appearance in case that images are displayed on each external display have consistent visual appearance. Accordingly, the electronic device 100 may provide a consistent visual experience to users viewing the video wall from the position of the electronic device 100.

According to an embodiment, at least some of the operations described with the electronic device 100 as the subject in the descriptions of the drawings may be implemented by the at least one processor 110 executing at least one instruction 121.

Various example embodiments described above may be implemented as software including instructions stored in a device-readable storage medium, in the form of a storage medium that is included in a computer program product and is readable by a device, or in a storage medium that may be distributed online through an application store or readable by a computer or a similar device using software, hardware, or a combination thereof.

Each component according to various embodiments described above may be configured as a singular entity or plural entities, and some ancillary components may be omitted or further included. Some components may be integrated into a single entity, performing functions that are identical or similar to those executed by each respective component prior to integration.

The operations according to various embodiments described above may be executed sequentially, in parallel, repetitively, or heuristically. Additionally, at least some operations may be executed in a different order, omitted, or other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory including at least one storage medium storing instructions;
display; and
at least one processor, comprising processing circuitry, wherein at least one processor, individually and/or collectively, is configured to cause the electronic device to:
perform first image processing on an original image to obtain at least one intermediate image, the at least one intermediate image including an image for display via an external reflective display device;
perform second image processing on the at least one intermediate image, based on at least one of ambient condition information or positional relationship information, to obtain at least one simulation image, the ambient condition information including ambient illuminance information, and the positional relationship information including information about at least one of a distance and/or a direction of the reflective display device relative to the electronic device; and
display the at least one simulation image via the display.

2. The electronic device of claim 1, wherein the second image processing is performed based on the ambient condition information, the positional relationship information, and optical characteristic information of the reflective display device, and wherein the optical characteristic information of the reflective display device includes at least one of reflectance of a display of the reflective display device or display luminance of the reflective display device.

3. The electronic device of claim 2, wherein at least one processor, individually and/or collectively, is configured to cause the electronic device to generate optical characteristic information of the reflective display device based on red-green-blue (RGB) data obtained by capturing the display of the reflective display device and ambient illuminance information.

4. The electronic device of claim 2, wherein the second image processing is performed based on the ambient condition information, the positional relationship information, the optical characteristic information of the reflective display device, display performance information of the reflective display device, and display performance information of the electronic device, and wherein the ambient condition information further includes at least one of position information of an ambient light source or ambient color temperature information, and the performance information includes at least one of size or resolution.

5. The electronic device of claim 1, wherein the first image processing includes image processing obtaining a plurality of different intermediate images based on different image processing setting information for an original image, the image processing setting information including information about an image processing algorithm, the plurality of intermediate images including at least one of a plurality of images obtained based on different types of image processing algorithms and/or a plurality of images obtained based on a same type of image processing algorithm and different attribute values, and wherein the second image processing includes image processing obtaining a plurality of simulation images from the plurality of intermediate images based on at least one of the ambient condition information and/or the positional relationship information.

6. The electronic device of claim 5, wherein at least one processor, individually and/or collectively, is configured to cause the electronic device to: transmit, to the reflective display device, a signal causing at least one intermediate image corresponding to at least one image selected among the plurality of intermediate images to be displayed as a final image, based on identifying the selection of the at least one image from the plurality of simulation images, and wherein the reflective display device is configured to display the final image based on the received signal.

7. The electronic device of claim 1, wherein the simulation image comprises an image related to an appearance to be seen from a position of the electronic device corresponding to the positional relationship information based on the at least one intermediate image being displayed via the display of the reflective display device.

8. The electronic device of claim 1, wherein at least one processor, individually and/or collectively, is configured to cause the electronic device to:
identify a change in the ambient condition information; and
display a simulation image updated based on the change in the ambient condition information via the display.

9. The electronic device of claim 1, wherein at least one processor, individually and/or collectively, is configured to cause the electronic device to adjust brightness displaying the simulation image on the display based on at least one of the ambient condition information and/or display brightness setting information of the electronic device.

10. The electronic device of claim 1, wherein at least one processor, individually and/or collectively, is configured to cause the electronic device to:
capture an image of a real space including the reflective display device;
identify a position and a shape of the reflective display device in the image of the real space;
overlay the simulation image on the shape of the reflective display device on the image of the real space; and
display the image of the real space and the overlaid simulation image on the display.

11. The electronic device of claim 1, wherein the positional relationship information includes: first positional relationship information between the electronic device and an external first reflective display device and second positional relationship information between the electronic device and an external second reflective display device, and wherein at least one processor, individually and/or collectively, is configured to cause the electronic device to: perform first image processing on a first original image to obtain at least one first intermediate image and a second intermediate image, the first intermediate image including an image for display via the first reflective display device, and the second intermediate image including an image for display via the second reflective display device, wherein a first simulation image obtained by second image processing based on the ambient condition information and the first positional relationship for the first intermediate image has a same visual appearance as a second simulation image obtained by second image processing based on the ambient condition information and the second positional relationship for the second intermediate image, and wherein the same visual appearance includes an appearance having a same or similar shape and same perceptual image features within a specified error range.

12. The electronic device of claim 11, wherein at least one processor, individually and/or collectively, is configured to cause the electronic device to: perform first image processing on a second original image to obtain at least one third intermediate image, the third intermediate image including an image for display via the second reflective display device, wherein a third simulation image obtained by second image processing based on the ambient condition information and the second positional relationship for the third intermediate image has a consistent visual appearance with the first simulation image, and wherein the consistent visual appearance includes an appearance having same perceptual image features within a specified error range.

13. A method of operating an electronic device, the method comprising:
performing first image processing on an original image to obtain at least one intermediate image;
performing second image processing on the at least one intermediate image based on at least one of ambient condition information or positional relationship information to obtain at least one simulation image; and
displaying the at least one simulation image through a display of the electronic device, wherein the at least one intermediate image includes an image for display via an external reflective display device, the ambient condition information includes ambient illuminance information, and the positional relationship information includes information about at least one of a distance and/or a direction of the reflective display device relative to the electronic device.

14. The method of claim 13, wherein the second image processing is performed based on the ambient condition information, the positional relationship information, and optical characteristic information of the reflective display device, and wherein the optical characteristic information of the reflective display device includes at least one of reflectance of a display of the reflective display device or display luminance of the reflective display device.

15. The method of claim 14, further comprising generating optical characteristic information of the reflective display device based on RGB data obtained by capturing the display of the reflective display device and ambient illuminance information.

16. The method of claim 14, wherein the second image processing is performed based on the ambient condition information, the positional relationship information, the optical characteristic information of the reflective display device, display performance information of the reflective display device, and display performance information of the electronic device, and wherein the ambient condition information further includes at least one of position information of an ambient light source and/or ambient color temperature information, and the performance information includes at least one of size and/or resolution.

17. The method of claim 13, wherein the first image processing includes image processing obtaining a plurality of different intermediate images based on different image processing setting information for an original image, the image processing setting information including information about an image processing algorithm, the plurality of intermediate images including at least one of a plurality of images obtained based on different types of image processing algorithms or a plurality of images obtained based on a same type of image processing algorithm and different attribute values, and wherein the second image processing is image processing obtaining a plurality of simulation images from the plurality of intermediate images based on at least one of the ambient condition information or the positional relationship information.

18. The method of claim 17, further comprising:
identifying selection of at least one image from the plurality of simulation images; and
transmitting, to the reflective display device, a signal causing at least one intermediate image corresponding to at least one image selected among the plurality of intermediate images to be displayed as a final image, based on identifying the selection of the at least one image.

19. The method of claim 13, wherein the simulation image includes an image related to an appearance to be seen from a position of the electronic device corresponding to the positional relationship information based on the at least one intermediate image being displayed via the display of the reflective display device.

20. The method of claim 13, further comprising:
capturing an image of a real space including the reflective display device;
identifying a position and a shape of the reflective display device in the image of the real space;
overlaying the simulation image on the shape of the reflective display device on the image of the real space; and
displaying the image of the real space and the overlaid simulation image on the display.
